(19) United States
(12) Patent Application Publication
(10) Pub. No.: US 2026/0189472 A1
(43) Pub. Date: Jul. 2, 2026

(54) ARTIFICIAL INTELLIGENCE MODEL COORDINATION BETWEEN NETWORK AND USER EQUIPMENT

(71) Applicant: Apple Inc., Cupertino, CA (US)

(72) Inventors: Peng Cheng, Beijing (CN); Fangli Xu, Beijing (CN); Haijing Hu, Los Gatos, CA (US)

(73) Assignee: Apple Inc., Cupertino, CA (US)

(21) Appl. No.: 19/125,927

(22) PCT Filed: Nov. 3, 2022
(86) PCT No.: PCT/CN2022/129610

§ 371 Date: Apr. 30, 2025

(51) Int. Cl. H04L 41/16; H04W 8/22; H04W 76/10; H04W 76/20

(52) U.S. Cl. CPC H04L 41/16; H04W 8/22; H04W 76/10; H04W 76/20

(57) ABSTRACT

The present application relates to artificial intelligence (AI) model coordination between a network and a UE. In an example, the network can indicate AI model formats that the network supports to the UE, and the UE can select a format for an AI model to be used by the UE and/or network for a network function. Additionally, or alternatively, the UE can indicate AI model formats that the UE supports to the network, and the network can select a format for an AI model to be used by the UE and/or network for a network function. In both cases, an AI model operation can be performed using the selected AI model format, where this operation can include any of an AI model transfer, an AI model inference, or an AI model training. A UE state change can occur and can trigger additional UE-network coordination related to the AI model operation.

### TECHNICAL FIELD

This application relates generally to wireless communication systems, and in particular relates to artificial intelligence model coordination between network and user equipment.

### BACKGROUND

Third Generation Partnership Project (3GPP) Technical Specifications (TSs) define standards for wireless networks. These standards can include, for example, long term evolution (LTE) (e.g., 4G), 3GPP new radio (NR) (e.g., 5G), and other standards.

### BRIEF DESCRIPTION OF THE DRAWINGS

FIG. 1 illustrates a network environment in accordance with some embodiments.

FIG. 2 illustrates an example of using an artificial intelligence (AI) model for a network function in accordance with some embodiments.

FIG. 3 illustrates an example of AI model data in accordance with some embodiments.

FIG. 4 illustrates examples of user equipment (UE)-network coordination associated with using AI models in accordance with some embodiments.

FIG. 5 illustrates an example of UE-network coordination associated with using AI models during a handover in accordance with some embodiments.

FIG. 6 illustrates an example of states of a UE in accordance with some embodiments.

FIG. 7 illustrates an example of UE-network coordination associated with using AI models during a UE state change in accordance with some embodiments.

FIG. 8 illustrates an example of an operational flow/algorithmic structure implemented by a UE for coordinating AI model usage with a network in accordance with some embodiments in accordance with some embodiments.

FIG. 9 illustrates an example of an operational flow/algorithmic structure implemented by a network for coordinating AI model usage with a UE in accordance with some embodiments in accordance with some embodiments.

FIG. 10 illustrates an example of receive components in accordance with some embodiments.

FIG. 11 illustrates an example of a UE in accordance with some embodiments.

FIG. 12 illustrates an example of a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

Embodiments of the present disclosure relate to artificial intelligence (AI) model coordination between a network and a UE. In an example, the network and/or the UE may support a set of AI models and, for each AI model, a set of AI model formats. The network can indicate the AI model formats that the network supports to the UE, and the UE can select a format for an AI model to be used by the UE and/or network for a network function. Additionally, or alternatively, the UE can indicate the AI model formats that the UE supports to the network, and the network can select a format for an AI model to be used by the UE and/or network for a network function. In both cases, an AI model operation can be performed using the selected AI model format, where this operation can include any of an AI model transfer (e.g., the network sending an AI model that has the selected AI model format to the UE, or vice versa), an AI model inference (e.g., the UE and/or the network performing an inference using an AI model having the selected AI model format), or an AI model training (e.g., the UE and/or the network training an AI model having the selected AI model format). A connection change can occur (e.g., a handover from a source base station to a target base station of the network) and/or a UE state change can occur (e.g., a change between a radio resource control (RRC) connected state, RRC idle state, and/or RRC inactive state). In both cases, the UE and the network (e.g., the source base station and/or the target base station as applicable) can exchange information about the AI model operation (e.g., whether to continue, stop, release, discard the use of the AI model and related AI data). These and other features are more described herein below.

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components of devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

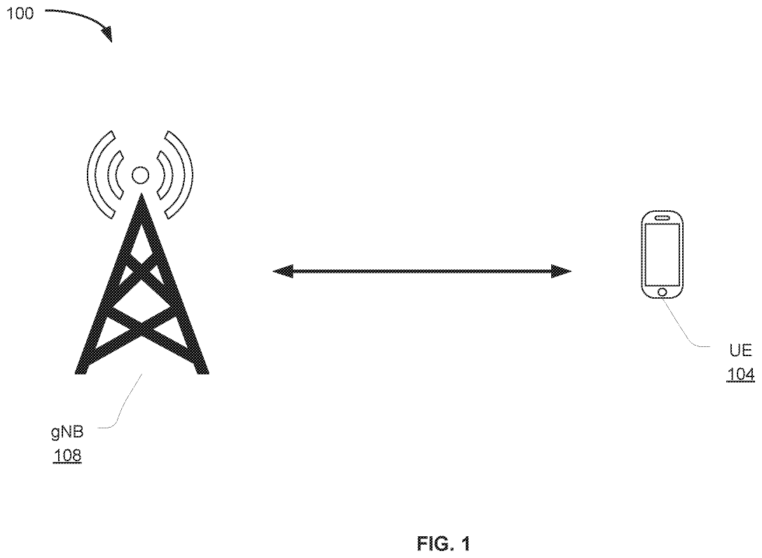

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include DMRSs for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission. The UE 104 can similarly transmit various reference signal to the gNB 108 including, for instance, DMRSs, for processing by the gNB 108 in association with uplink channels (e.g., a physical uplink control channel (PUCCH) and a physical uplink shared channel (PUSCH)).

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a PUCCH and a PUSCH. Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band, frequency range 2 (FR2) band, and/or high frequency range (FRH) band. The FRI band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

Although not illustrated in FIG. 1, the network environment 100 may other network components. For example, the network environment 100 can use various radio access networks (RANs) for communicating between a UE (e.g., the UE 104) and a base station (e.g., the NB 108) of the RAN (which may also sometimes be referred to generally as a RAN node, a network node, or simply a node). For 5G-NR, 3GPP RANs can be referred to as a Next-Generation Radio Access Network (NG-RAN).

Each RAN may use one or more radio access technologies (RATs) to perform communication between the base station and the UE. For example, NG-RAN implements NR RAT (sometimes referred to herein as 5G RAT, 5G NR RAT, or simply NR). In certain deployments, NG-RAN may also implement long term evolution (LTE) RAT.

A base station (e.g., the gNB 108) used by a RAN may correspond to that RAN. A RAN provides its communication services with external entities through its connection to a core network (CN). For example, NG-RAN may utilize a 5G Core Network (5GC). As used herein, a “network” can refer to any or a combination of a base station, a RAN, or a CN.

In the interest of clarity of explanation, various embodments of the present disclosure are described in the context of the 5G NR. However, the embodiments are not limited as such and can similarly and equivalently apply to other wireless communication systems, such as the 4G LTE/LTE-A, or various wireless communication systems to be developed in future. Equivalents to the architecture, entities, functions, processes and the like as described in the present disclosure may be found in these communication systems. Various embodiments are also described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

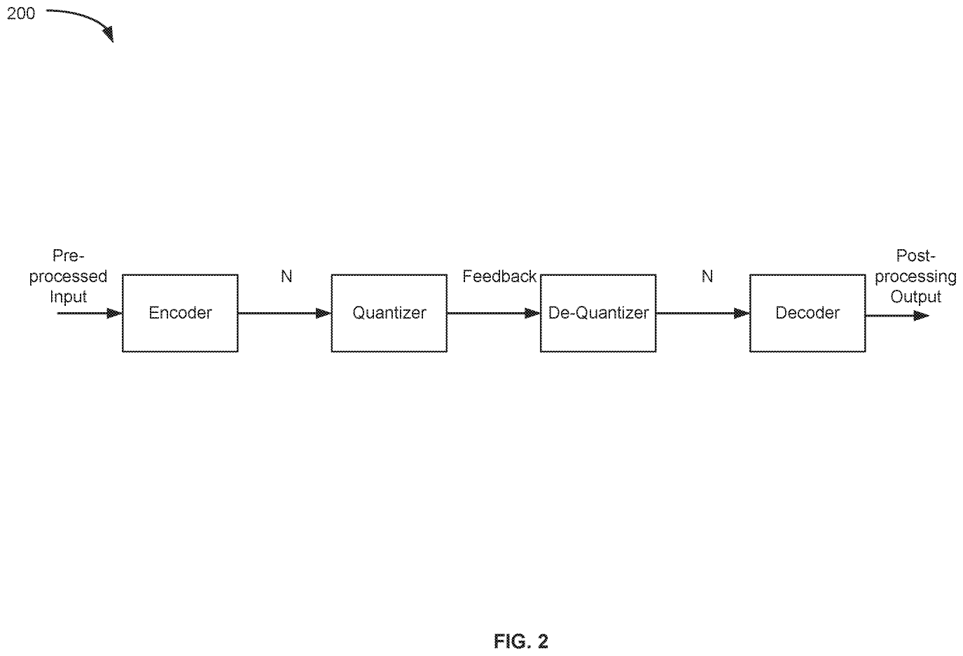

FIG. 2 illustrates an example 200 of using an AI model for a network function in accordance with some embodiments. Application of AI models to the wireless communication systems can depend on a level of collaboration between a UE and a network. Various levels of collaboration may be possible including, for example, as no collaboration (e.g., the UE uses an AI model independently of and without coordination with the network, or vice versa), signaling-based collaboration without model transfer (e.g., the UE indicates an AI model that the UE uses to the network without transferring such a model to the network, or vice versa), signaling-based collaboration with model transfer (e.g., the UE indicates an AI model that the UE uses and/or the network to use to the network and transfers such a model to the network, or vice versa), etc.

Generally, an AI model can be implemented to provide a machine or system with ability to simulate human intelligence and behavior. Different types of AI models are possible including, for example, neural network (NN), such as convolutional neural network (CNN), recurrent/recursive neural network (RNN), generative adversarial network (GAN), or the like. Air interface design may be augmented with features enabling improved support of AI models for enhanced performance and/or reduced complexity/overhead. Enhanced performance depends on use cases under consideration and could be, for example, improved throughput, robustness, accuracy or reliability, etc. The use cases may include channel state information (CSI) feedback enhancement (e.g., for overhead reduction, improved accuracy, prediction or the like), beam management (e.g., for beam prediction in time, and/or spatial domain for overhead and latency reduction, beam selection accuracy improvement, or the like), and positioning accuracy enhancements for different scenarios including (e.g., for those with heavy Non-Line of Sight (NLOS) conditions) to name a few use cases.

In the illustration of FIG. 2, the CSI feedback enhancement use case is shown. Massive multiple-input multiple-output (MIMO) systems rely on CSI feedback to perform precoding and achieve performance gain. However, the huge number of antennas in MIMO systems can pose a challenge to conventional CSI feedback reduction methods and leads to excessive feedback overhead. Auto-encoder/decoder-based CSI feedback enhancement is an example of an approach for addressing this challenge. FIG. 2 shows a general structure of the auto-encoder/decoder-based CSI feedback. As shown in FIG. 2, on the UE side, preprocessed CSI input is encoded by an encoder which may be an AI model, and quantized by a quantizer, and then is transmitted to the network. On the network side, the CSI feedback is dequantized by a de-quantizer, and decoded by a decoder which may also be an AI model, so as to calculate a precoder.

The encoder AI model can be an encoder NN, whereas the decoder AI model can be a decoder NN. The encoder/decoder-based approach preferably trains the overall encoder and decoder NN by deep learning, so as minimize the overall loss function of the decoder output versus the encoder input. The encoder/decoder training can be centralized (e.g., local to the UE or to the network), while the inference function is split between UE and NG-RAN node (e.g., gNB), that is, encoder inferencing is at the UE, and decoder inferencing is at the gNB. To achieve this, UE-gNB collaboration with model transfer over the air may be needed.

In this example 200, the NN including both of the encoder and the decoder is a two-sided model. If the NN is trained and owned at the network side, for example, by a network device vendor, a part of the NN (i.e., the auto-encoder for inference at the UE) needs to be downloaded to the UE. If the NN is trained and owned at the UE side, for example, by the UE vendor, a part of the NN (i.e., the auto-decoder for inference at the gNB side) needs to be uploaded to the gNB. Furthermore, the NN may be trained and owned by a third party, and two parts of the NN need to be transferred to the UE and the gNB, respectively.

Alternatively, the encoder NN or the decoder NN may be trained separately as a one-sided model. For example, the UE vendor may train only the encoder NN based on downlink measurement data in different cells, and the network device vendor may train only the decoder NN based on uplink data for different UEs. In this case, the UE and the gNB may acquire respective NNs from a server of the UE vendor and a server of the network device vendor, respectively.

On the one hand, the network may have different deployments, such as indoor, Umi or Uma deployment, different number of antennas deployed in the cell, a single TRP (sTRP) or multiple TRPs (mTRP), and thus a number of NNs may be trained to enable flexible adaptive codebook design and to optimize the system performance. On the other hand, the UE may have different individual AI capability, or memory limitation, and thus a number of NNs may be trained to adapt to UE differentiation.

Moreover, depending on where the AI model is trained (e.g., where the intelligence is), its model file may be stored in a vendor server, a third party host, or the operator network. The AI model can be transferred to UE or gNB, depending on where the inference is performed.

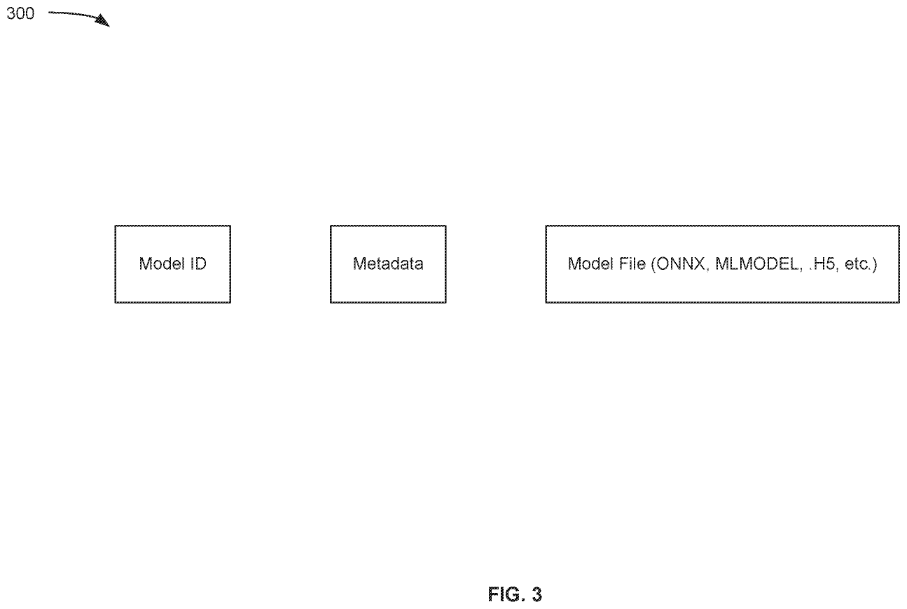

FIG. 3 illustrates an example of AI model data 300 in accordance with some embodiments. The AI model data 300 can define an AI model. Several AI models may be available to a UE or a base station, which may be trained by different entities. The UE or the base station may receive a plurality of different models and store them in local memory. One of these models may be activated for use as appropriate. For example, the network may activate, deactivate or switch the AI model at the UE via signaling. Alternatively, the UE may select the AI model to be used and inform the network of its selection.

A unique AI model identifier (ID) can be assigned to each of the AI models. The AI model ID is used to identify the AI model unambiguously, for example, within a public land mobile network (PLMN) or among several PLMNs. In an example, the AI model ID may include any or a combination of a network device vendor identification, a UE vendor identification, a PLMN ID, a use case ID, a number of the AI model for this use case. The network device vendor identification represents the network vendor which has trained the AI model, and the UE vendor identification represents the UE vendor which has trained the AI model. The PLMN ID represents the operator network in which the AI model is applied. In addition, the use case ID represents the use case to which the AI model is directed, and optionally, if there is more than one AI model for a particular use case, the number of the AI model for this use case is used to differentiate between them.

The AI model may be stored and transferred as the AI model data 300, which includes a model file in association with the AI model ID and metadata. The metadata is generated to describe the AI model, and may indicate various information regarding the AI model, including any or a combination of a training status (e.g., whether the AI model is trained and tested network, and potential training data set indication of the AI model), parameters of a network function that the AI model supports (e.g., functionality/object, input/output of the AI model), latency benchmarks, memory requirements, accuracy of the AI model, compression status of the AI model, inferencing/operating condition (e.g., urban, indoor, dense macro, etc.), and pre-processing and post-processing of the measurement for AI input/output.

The model file may contain model parameters for constructing the AI model. In the case of deep neural network, the model file may include layers and weights/bias of the neural network. The model is saved in a file depending on the machine learning framework that is used. For example, a first machine learning framework may save a file in a first format, while a second machine learning framework may save a file in a different format to represent the AI models.

Due to diverse model formats in current AI industry, it is expected that AI models (or even the same network function AI model) trained by different vendors can have different AI model formats, such as ONXX, MLMODEL, .H5, etc. The model file may need reformatting before, during or after it is transferred to the UE or the base station. Assuming that the AI model is stored in a first AI model format after being trained, but the UE or the base station may support a second AI model format different from the first format, then a model conversion can be performed (e.g., by converting the model file format from the first AI model format to the second AI model format, and optionally converting the metadata to be a format usable by the target). As an example, a server storing the AI model may perform the model conversion before transmitting the AI model. As another example, a network function (NF) in a core network may perform the model conversion before forwarding the AI model data 300 to the base station. As yet another example, the base station may take the responsibility to perform the model conversion for the AI model destined for the base station or for the UE, in latter case, the base station then forwards the AI model data 300 to the UE. As yet another example, it is the UE that performs the model conversion according to the UE's support capability. Further, the AI model data 300 may be compressed for storage and/or transfer, for example, by using standard compression methods provided in ISO-IEC 15938-17 or any other possible compression methods.

In an example, when an AI model is to be used (e.g., transferred between a network and UE, trained by the network and/or UE, operated for inference by the network and/or the UE), a coordination between the network and the UE may occur. This coordination can include, among other things, the exchange of information to determine an AI model format to use (e.g., one of the file formats such as ONXX, MLMODEL, H5, etc.). In this case, model conversion may not occur if an AI model file is already available and has the AI model format. Otherwise, the model conversion can be performed to generate the AI model file having the AI model format.

Different techniques are available for an AI model transfer. In an example, the AI model data 300 may be application data. In this example, an over the top (OTT) technique may be implemented. The AI model data 300 is transmitted as application-layer data through a tunnel provided by an operator network, where the UE or base station receives, and decapsulates protocol data units (PDUs) carrying the model data and forwards the model data to its application layer.

In another example, the AI model data 300 may not be application-layer data. Instead, the AI model data 300 may be configured for use in lower layers, such as the PHY layer, and thus needs not be forwarded to the application layer. In addition, the base station and the UE both need to be aware of the AI model, so that they can perform inference jointly and life cycle management of the AI model. The OTT solution is transparent to the NR network and prevents UE and base station joint AI operations to happen. In this case, the AI model data 300 may be transferred to the UE or base station via a core network and a RAN. For example, the UE can receive protocol data units (PDUs) carrying the AI model data 300 in a control plane or a user plane.

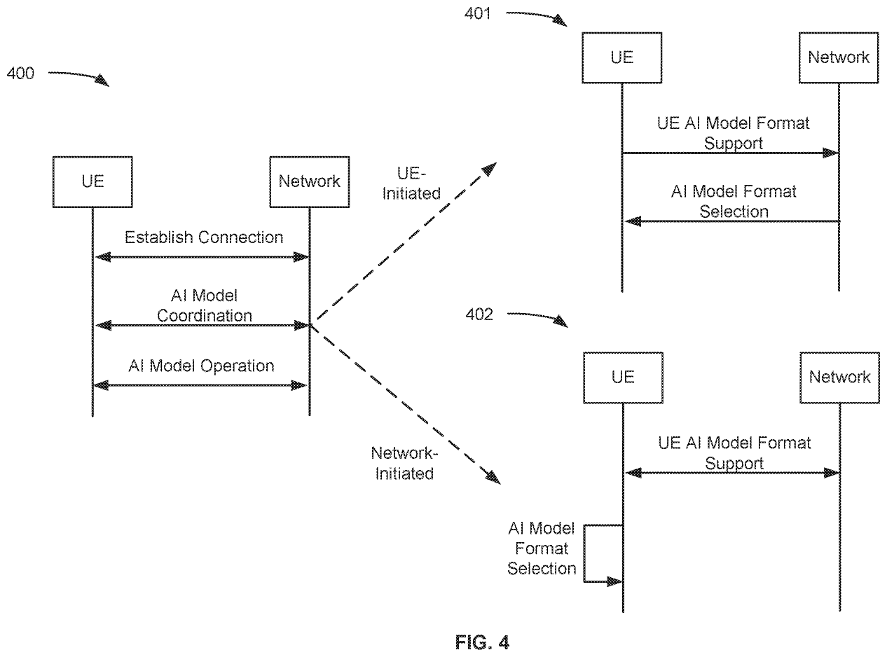

FIG. 4 illustrates examples of UE-network coordination 400 associated with using AI models in accordance with some embodiments. As illustrated, the UE-network coordination 400 can include a UE establishing a connection with a network. For example, in the context of a 5G NR wireless system, a 3GPP connection procedure can be performed and can include establishing an RRC connection between the UE and a gNB (e.g., by using RRC signaling including, for instance, RRC connection reconfiguration messages), which in turn connects to the 5G CN. Next, an AI model coordination between the UE and the network can occur to determine an AI model format for an AI model to use for a network function. This coordination can be initiated by the UE as shown in a UE-initiated AI model format coordination 401 diagram on the right hand side of FIG. 4. Additionally, or alternatively, coordination can be initiated by the network as shown in a network-initiated AI model format coordination 402 diagram on the right hand side of FIG. 4. In both cases, the AI model can be hosted by the UE, or the network and the use can include any of transfer of the AI model (e.g., from the UE to the network, or vice versa), a training of the AI model (e.g., by the UE or the network), or inference using AI the model (e.g., by the UE or the network). After the initial AI model format coordination, an AI model operation can be performed by the UE and/or the network. For example, this operation can include any of the AI model transfer, the Al model training, or the AI model inference and is further described herein below in connection with the next figures.

In the interest of clarity of explanation, such an AI model operation is described in connection with a single AI model. However, the embodiments similarly and equivalently apply to an AI model operation that uses multiple AI models (e.g., a transfer of more than one AI model) and/or multiple AI model operations each of which can use one or more AI models (e.g., an AI model transfer of a first set of AI models, an AI model training of a second set of AI models, and an AI model inference using a third set of AI models).

In an example, the UE-initiated AI model format coordination 401 the UE sending information indicating the AI model formats that the UE supports to the network. In turn, the network can select at least one of the AI model formats and indicates this selection to the UE. Next, the UE can perform the AI model operation using the selected AI model format(s).

The information indicating the AI model format that the UE supports can be included in UE capability information and/or metadata that is part of AI model data (e.g., the AI model data 300 of FIG. 3). In the case of using UE capability information, the AI model format support information can be included in one or more access stratum (AS) messages of the UE to a base station of the network. In turn, the base station can indicate the AI model format selection to use via one or more RRC messages. This UE-base station coordination can apply when the AI model is to be transferred to or received from the base station (rather than from a network entity of the core network), training data or outcome is to be transferred to or received from the base station (rather than from a network entity of the core network), and/or an inference result is be transferred to or received from the base station (rather than from a network entity of the core network). For example, the base station hosts the AI model (e.g., or more generally, the AI model functionality). An information element (IE) can be included in a UECapabalityInformation message and indicates the AI model format(s) supported by the UE (e.g., as “supportedModelFileFormat”). For each supported AI model format, this indication can include a description of the AI file format, an identifier of the file format (e.g., ONNX, MLMODEL, H5, etc.), and/or an index that the base station can use to determine the file format.

Still in the case of using UE capability information, when a core network entity is involved rather than the base station (e.g., a user plane function (UPF), an access and mobility management function (AMF), or another network function (NF) of the core network), non-access stratum (NAS) signaling can be used instead. In particular, the UE sends one or more NAS capability messages indicating the UE-supported AI model formats and the core network indicates back the AI model format selection via NAS signaling. In this case, the core network entity hosts the AI model (e.g., or more generally, the AI model functionality). The NAS capability message can include a registration request message. And the AI model format selection is indicated in a registration accept message.

In the case of using the metadata, this metadata can be sent to either the base station or the network as applicable (e.g., depending on where the AI model functionality is hosted). For example, the UE indicates the UE-supported AI model format(s) in the metadata of a header (without an empty payload, such that the actual AI model file is not included). In turn, the network (e.g., base station or a core network entity as applicable) can check with the server hosting the AI model functionality to at least one of the UE-supported AI model formats that the server also supports and can then identify, to the UE, the AI model format selection indicating this at least one AI model format. In an illustrative use case, the UE can send only the AI model identifier of the AI model and the metadata (rather than the entire set of AI model data), where this metadata includes, for each supported AI file format, a description of the file format, an identifier of the file format (e.g., ONNX, MLMODEL, .H5, etc.), and/or an index that the network can use to determine the file format. The network can then send a response that include the artificial model identifier and metadata rather than the entire set of AI model data), where this metadata includes, for each selected AI file format, a description of the file format, an identifier of the file format (e.g., ONNX, MLMODEL, .H5, etc.), and/or an index that the UE can use to determine the file format.

In an example, the network-initiated AI model format coordination 402 can involve the network (e.g., the base station or a core network depending on where the AI model functionality is hosted) sending a broadcast of the network-supported AI model format(s). For example, the base station can send such broadcast in one or more system information block (SIB) messages. Next, the UE can select one or more of the network-supported AI model format(s), where a selected format is one that the UE determines that it is supported locally by the UE. If more than one AI model format can be supported by the UE, the UE can make the selection based on its implementation (e.g., configuration data of the UE defined by a UE vendor and prioritizing the selection) and/or based on a priority list defined by another entity (e.g., a priority list preconfigured in a subscription of the UE with a network operator). Optionally, the UE can indicate its selection to the network.

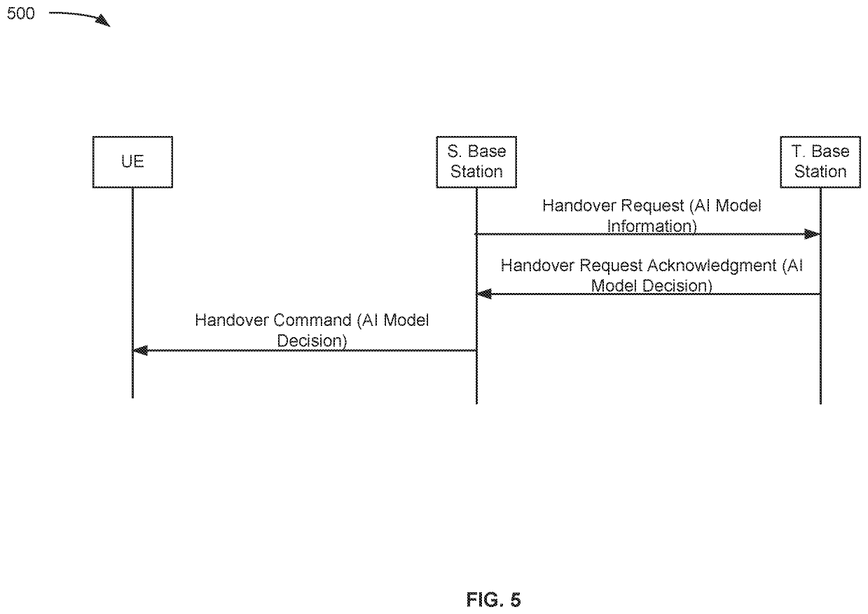

FIG. 5 illustrates an example of UE-network coordination 500 associated with using AI models during a handover in accordance with some embodiments. In this example, a UE is connected with a source base station that provides at least a primary cell (PCell) to the UE. An AI model operation is being performed, such as a transfer of an AI model from the UE to the source base station or vice versa, a training of an AI model by the UE or the source base station such that a training outcome is sent to the base station or the UE as the case may be, and/or an inference using an AI model by the UE or the source base station such that an inference result is sent to the base station or the UE as the case may be. One or more triggers are detected (e.g., low channel quality due to UE mobility, etc.) and a handover procedure is performed and involves the UE, the source base station, and a target base station. Upon completion of the handover procedure, the UE is connected with the target base station that provides at least a PCell to the UE. In this handover situation, the UE-network coordination 500 is usable to coordinate the execution of the AI model operation not only between the UE and the source base station, but also with the target base station. UE-network coordination 500 involves, among other things, identifying the AI model format(s) that is(are) in use to the target base station and generating decisions about such a use depending on the possible support of the target base station.

In the interest of clarity of explanation, an AI model having an AI model format is described as being in use while the handover procedure is being performed.

However, the embodiments similarly and equivalently apply to an AI model operation during the handover, where such an operation uses multiple AI models (e.g., a transfer of more than one AI model), and/or multiple AI model operations during the handover, where each of such operations can use one or more AI models (e.g., an AI model transfer of a first set of AI models, an AI model training of a second set of AI models, and an AI model inference using a third set of AI models).

As illustrated, the source base station sends a handover request to the target base station as part of performing the handover procedure. According to the UE-network coordination 500, this handover request can include information about the AI model format of the AI model that is in use, in addition to possibly other information about the AI model (e.g., its AI model identifier and metadata, but excluding possibly the actual AI model file). The target base station can then determine whether it can also support the AI model format and can generate an AI model decision based on this decision. For example, this decision can be to continue using the AI model format in case this format is supported in the first place by the target base station and the target base station can the capacity to support the AI model operation (e.g., to continue the AI model transfer, continue the AI model training, or continue the AI model inference). Alternatively, the decision can be to stop using the AI model format in case this format is unsupported by the target base station or the target base station lacks the capacity to support the AI model operation.

In an example, the UE can support multiple AI model formats for the AI model in use and may be using one of the supported AI model formats when the handover procedure is started. Rather than merely indicating the AI model format that is in use, the handover request can indicate all of the UE-supported AI models and can optionally identify the one in use. In this case, the target base station can select one of the UE-supported AI models that it also supports, which may but need not be the same as the one that is currently in use. This selection can depend on a number of factors, such as a priority list configured or predefined for the target base station, available capacity of the source base station to perform the AI model operation depending on target base station-supported AI model format, and/or an attempt to continue using the AI model format that is in current use if the target base station has the capacity. In this case, the AI model decision generated by the target base station can indicate the selected AI model format if different from the one currently in use.

The target base station can send a handover request acknowledgement to the source base station as part of performing the handover procedure. This acknowledgement can include the AI model decision according to the UE-network coordination 500. In turn, the source base station can send a handover command to the UE, such that the UE connects with the target base station. The handover command can indicate the AI model decision according to the UE-network coordination 500. In particular, this command can indicate whether the UE should continue performing the AI model operation or not. If the UE should continue performing the AI model operation, the handover command can indicate the AI model format to use (if different from the one currently in use). If the UE should not continue performing the AI model operation, the handover command can instruct the UE about how to terminate the AI model operation (e.g., what to do with the already transferred AI model data, AI training outcomes, AI inference results, etc.).

In an example, for each AI model that is being transferred, the source base station forwards the following information of the UE to the target base station via one or more handover request messages: the AI model identifier, metadata about the AI model, and the AI model format for the AI model. For each AI model that is being trained by the UE, the source base station forwards the following information of the UE to the target base station via one or more handover request messages: the AI model identifier, metadata about the AI model, and the AI model format for the AI model. For each AI model that is being used for inference by the UE, the source base station forwards the following information of the UE to the target base station via one or more handover request messages: the AI model identifier, metadata about the AI model, and the AI model format for the AI model.

Upon reception of the information included in the one or more handover request messages, the target base station decides which AI model(s) can be kept or released for transfer, and/or training, and/or inference, and sends the indication in one or more handover request acknowledge message. Keeping an AI model can involve continuing the use of the AI model (although possibly switching the used AI model format from a first format to a second format, where the second format is also supported by the UE). Releasing an AI model can involve stopping the use of the AI model without the need to delete this AI model from memory (but this deletion may also be possible). The target base station makes decisions on release/keep based on factors, such as its capability, its capacity, the connection to the core network, etc. The UE can release a stored AI model indicated in the handover command to release, and discard the unfinished PDCP PDU(s) if the model is in transfer, stop training and release the training outcome if the model is in training (e.g., by sending this training outcome to the source base station and/or target base station and/or storing it locally in its memory), and stop inference and discard the stored inference results if the model is used for inference.

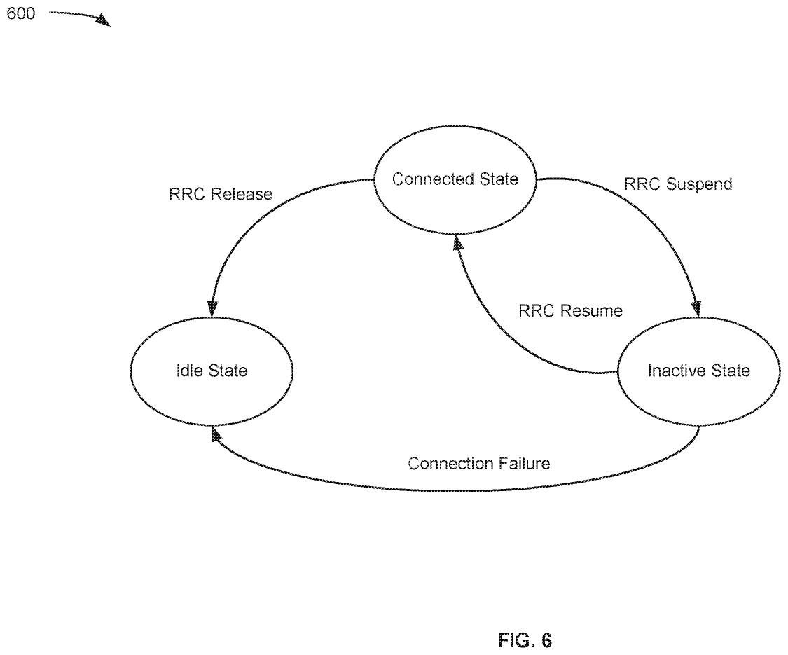

FIG. 6 illustrates an example of states of a UE in accordance with some embodiments. In an example, the UE is connected with a base station and has already provided an indication of the AI model format(s) that it can support per AI model and has received an indication of the AI model format to use per AI model operation, and/or has received a broadcast of AI model format(s) that a network (e.g., including the base station) supports per AI model and has selected an AI model format to use per AI model operation. While one or more AI model operation(s) are being performed according to one or more AI model formats, the UE can be operating in a first state from possible states that include an RRC connected state and an RRC inactive state. Due to different triggers, the UE can switch to a second state of possible states. For example, the UE can switch from the RRC connected state to the RRC inactive state according to an RRC suspend message of the base station, from the RRC connected state to the RRC idle state according to an RRC release message of the base station, from the RRC inactive state to the RRC idle state according to an RRC connection failure message of the base station, or from the RRC inactive state to the RRC connected state according to an RRC resume message of the base station.

Coordination between the UE and the network about the AI model format(s) to use and/or the AI model operation(s) upon the switch to the second state may be needed. Such coordination is further described in the next figure herein below.

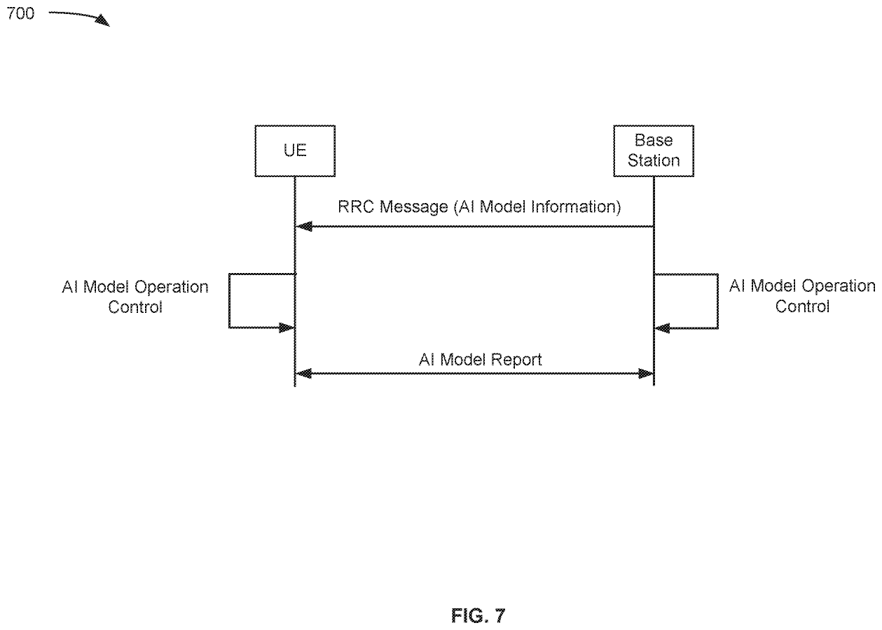

FIG. 7 illustrates an example of UE-network coordination 700 associated with using AI models during a UE state change in accordance with some embodiments. In the interest of clarity of explanation, an AI model having an AI model format is described as being in use while a UE state of a connection between a UE and a base station changes (e.g., from an RRC connected state to an RRC inactive state or an RRC idle state, or from an RRC inactive state to an RRC connected state or an RRC idle state as described in FIG. 6), However, the embodiments similarly and equivalently apply to an AI model operation during the UE state change, where such an operation uses multiple AI models (e.g., a transfer of more than one AI model), and/or multiple AI model operations during the UE state change, where each of such operations can use one or more AI models (e.g., an AI model transfer of a first set of AI models, an AI model training of a second set of AI models, and an AI model inference using a third set of AI models).

As illustrates, the base station sends an RRC message to the UE to instruct the UE about a change of its state from a first state to a second state. For example, this RRC message can be an RRC suspend message or an RRC release message for a change from the RRC connected state to the RRC inactive state or RRC idle state. In another example, this RRC message can be an RRC resume message or an RRC connection failure message for a change from the RRC inactive state to the RRC connected state or the RRC idle state. According to the UE-network coordination 700, the RRC message can include information about controlling the AI model operation once the UE state change is completed. This information can indicate, to the UE, about what to do with an AI model that is being transferred from the base station to the UE or vice versa, what to do with training outcomes of an AI model that is being trained by the UE or the base station, and/or what to do with inference results of an AI model being used by the UE or base station for inference. This information can also indicate other controls, such as timing controls for how long the AI model operation can continue to be performed (e.g., by the UE and/or the network) after the UE state change, cell information about cells for which the AI model operation can be used after the UE state change, identifier(s) of other AI model(s) to use after the UE state change, and/or identifier(s) of other AI model format(s) to use for the same AI model or other AI model(s) after the UE state change.

The UE receives the RRC message and changes its state. Based on the AI model information included in the RRC message, the UE controls the AI model operation when the AI model operation was being performed by the UE prior to the UE state change. This control can include keeping the AI model, releasing the AI model, storing training outcomes, discarding training outcomes, storing inference results, discarding inference results, switching to using another AI model format for the AI model operation, etc.

Before the UE state change is completed or upon its completion, the UE can send an AI model report to the base station. The AI model report can include any or a combination of training outcomes, inference results, and/or status of the AI model transfer (e.g., the amount of the AI model file that has been downloaded or uploaded and the last download/upload position). For example, when the UE is in the RRC connected state prior to the UE state change, the UE can send the AI model report upon receiving an RRC release message or an RRC suspend message. Conversely, when the UE is switched to the RRC connected state, the UE can send the AI model report upon receiving a RRC message resume message. When the UE is in the RRC inactive state prior to the UE state change or is switched to the RRC inactive state, the UE can send AI model report using a small data transmission (SDT) procedure while being in the RRC inactive state.

In the illustration of FIG. 7, the base station may also be performing an AI model operation prior to the UE state change and, based on the AI model information, the base station can also control the AI model operation after the UE state change. Such controls can be similar to the UE controls. In such cases, if the UE is also performing an AI model operation, the base station can receive an AI model report as described herein above. The base station can also send its AI model report to the UE prior to or after the UE state change.

Herein next, multiple use cases relate to UE state changes are described. Specific AI model information and AI model report are described for each use case. However, the embodiments of the present disclosure are not limited to only such use cases and/or to the specific AI model information or specific AI model report described for each use case.

A first example use case relates to changing the UE state from the RRC connected state to the RRC idle state. In this example, before being released to the RRC idle state, the UE may be performing one or more actions in the base station including an AI model transfer, an AI model training, and/or an AI model inference. Upon reception of the RRC release message to enter the RRC idle state, the UE can release all stored AI models, and discard the unfinished packet data convergence protocol (PDCP) PDU(s) for an AI model that is in transfer, stop training an AI model and release the training outcome (e.g., to the base station) if the model is in training, and/or stop inference and discard the stored inference results for an AI model that is used for inference.

A second example use case relates to changing the UE state from the RRC connected state to the RRC inactive state. In this example, before being released to the RRC inactive state, the UE may be performing one or more actions in the base station including an AI model transfer, an AI model training, and/or an AI model inference. The RRC release message (e.g., an RRC suspend message) to enter the inactive state may include the following IEs related to the AI model(s). For AI model inference, the IE(s) can indicate a list of AI model ID(s) to indicate to the UE to continue performing inference with these indicated AI model(s). For each of such AI models, the IE(s) can further indicate UE timer for how long the UE can continue the AI model inference and a list of cells to continue the AI model inference (e.g., in the case of using an AI model for CSI feedback, the IEs can indicate the cells for which CSI feedback is to be inferred using the AI model). For each AI model identified in the list of AI model identifier(s), the IE(s) can also indicate whether to suspend the inference but keep the configuration of the AI model (e.g., such that the AI model is not deleted, and the current inference state can be maintained).

For AI model training, the IE(s) can indicate a list of AI model ID(s) to indicate to the UE to continue performing local training for these indicated AI model(s). For each of such AI models, the IE(s) can further indicate UE timer for how long the UE can continue the local training and a list of cells to continue the local (e.g., in the case of training an AI model for CSI feedback using training data collected based on cell measurements, the IEs can indicate the cells for which additional training data can be collected and used in the training). For each AI model identified in the list of AI model identifier(s), the IE(s) can also indicate whether to suspend the training but keep the configuration of the AI model (e.g., such that the AI model is not deleted, and the current parameters of the AI model, such as the weights between connected nodes, can be maintained).

Upon reception of the RRC release message to enter the RRC inactive state, the UE can discard all the unfinished PDCP PDU(s) for AI model(s) in transfer. For AI model(s) in training but not identified in the list associated with the AI model training, the UE can release the stored AI model(s) (e.g., the ones not identified by the list), stop training and release the training outcome. For AI model(s) in training and identified in the list associated with the AI model training, the UE can suspend the training and, as applicable, keep the configuration of such AI model(s) (e.g., depending on a UE implementation, amount of available memory space of the UE, amount of used memory space, and/or the RRC release message). For each AI model in inference but not identified in the list associated with the AI model inference, the UE release this AI stored model, stop inference and discard the stored inference results if the AI model is being used for inference. For AI model(s) in inference and identified in the list associated with the AI model inference, the UE can suspend the inference and, as applicable, keep the configuration of such AI model(s) (e.g., depending on a UE implementation, amount of available memory space of the UE, amount of used memory space, and/or the RRC release message). Upon expiry of the timer(s) or move out of the configured cell list, the UE may stop local training and/or inference. The training outcome and/or inference result may be kept for reporting after the UE enters the RRC connected state.

A third example use case relates to changing the UE state from the RRC inactive state to the RRC connected state. In this example, before entering the RRC connected state, the UE may be performing one or more actions in the base station including an AI model training with training outcome stored (e.g., locally by the UE) and/or an AI model inference with inference results stored (e.g., locally by the UE).

During resumption (e.g., upon requesting the UE state change or receiving an RRC resume message), the UE can indicate to the network that it has a stored training outcome(s) and/or a stored inference result(s). For example, the UE can include a one-bit in an RRCResume Complete message to indicate it has stored training outcome and/or one-bit in the same or a different RRCResumeComplete message to indicate it has stored inference results. A bit mask in a singleRRCResumeComplete message can be used, where each bit can indicate that a stored training outcome(s) and/or a stored inference result(s) are available, or where each set of bits (e.g., two bits) is mapped to an AI model identifier and indicates, for the corresponding AI model, whether a stored training outcome(s) and/or a stored inference result(s) are available.

The base station can request the UE to report its stored training outcome(s) and/or inference results. Different signaling techniques are possible for such a request. In one example, the base station sends one or more indications requesting the AI model report in an RRCResume message and, in turn, the UE reports the AI model report in a RRCResumeComplete message per the network request. In another example, the base station sends one or more indications requesting the AI model report in an UEInformationRequest message (after the RRCResumeComplete message is received and the UE state has been changed to the RRC connected state), and the UE reports the AI model report in a UEInformationResponse message per the network request. The AI model(s) can be restored by the base station from the node hosting the UE context when the UE enters the RRC connected state. For an AI model training, the AI model report can include training outcomes. The training outcomes can include a list of: AI model ID(s) corresponding to the AI model(s) associated with the AI model training, updated parameter(s) and/or updated model structure for each of such AI models, a time stamp per AI model about when the last training is performed. For an AI model inference, the AI model report can include inference results. The training outcome can include a list of: AI model ID(s) corresponding to the AI model(s) associated with the AI model inference, inference metric(s) for each such AI model, and a time stamp per AI model about when the last interference is performed.

A fourth example use case relates to changing the UE state from the RRC inactive state to the RRC idle state. In this example, before being released to the RRC idle state, the UE may be performing one or more actions in the base station including an AI model training with training outcome stored (e.g., locally by the UE) and/or an AI model inference with inference results stored (e.g., locally by the UE).

Upon reception of the RRC release message to enter the idle state (e.g., a connection failure message), the UE can release all stored AI models. For each AI model in training, the UE stop training and release the training outcome if the AI model is in training. For each AI model in inference, the UE can stop inference and discard the stored inference results if the AI model is used for inference.

A fifth example use case relates to keeping the UE state as the RRC inactive state following a two-step resume where the UE attempts to change its UE state to the RRC connected state and is instructed by the base station to stay or re-enter in the RRC inactive state. In this example, before attempting the UE state change, the UE may be performing one or more actions in the base station including an AI model training with training outcome stored (e.g., locally by the UE) and/or an AI model inference with inference results stored (e.g., locally by the UE).

The RRC release message to send the UE back to the inactive state may include the following IEs related to the AI model(s). For AI model inference, the IE(s) can indicate a list of AI model ID(s) to indicate to the UE to continue performing inference with these indicated AI model(s). For each of such AI models, the IE(s) can further indicate UE timer for how long the UE can continue the AI model inference and a list of cells to continue the AI model inference (e.g., in the case of using an AI model for CSI feedback, the IEs can indicate the cells for which CSI feedback is to be inferred using the AI model). For AI model training, the IE(s) can indicate a list of AI model ID(s) to indicate to the UE to continue performing local training for these indicated AI model(s). For each of such AI models, the IE(s) can further indicate UE timer for how long the UE can continue the local training and a list of cells to continue the local (e.g., in the case of training an AI model for CSI feedback using training data collected based on cell measurements, the IEs can indicate the cells for which additional training data can be collected and used in the training).

Upon reception of the RRC release message to stay and/or enter the inactive state, the UE can perform different operations depending on whether an AI model is used for training or for inference and is identified in a relevant list of AI model(s). For AI model(s) in training but not identified in the list associated with the AI model training, the UE can release the stored AI model(s) (e.g., the ones not identified by the list), stop training and release the training outcome. For AI model(s) in training and identified in the list associated with the AI model training, the UE can suspend the training and, as applicable, keep the configuration of such AI model(s) (e.g., depending on a UE implementation, amount of available memory space of the UE, amount of used memory space, and/or the RRC release message). If a timer is configured, the UE can restart the timer and update the stored cell list. For each AI model in inference but not identified in the list associated with the AI model inference, the UE release this AI stored model, stop inference and discard the stored inference results if the AI model is being used for inference. For AI model(s) in inference and identified in the list associated with the AI model inference, the UE can suspend the inference and, as applicable, keep the configuration of such AI model(s) (e.g., depending on a UE implementation, amount of available memory space of the UE, amount of used memory space, and/or the RRC release message). Here also, if a timer is configured, the UE can restart the timer and update the stored cell list.

When the UE is in a RRC inactive state (e.g., as in the third, fourth, and fifth examples above), the UE may stop the local AI model operation (inference and/or training) due to the memory limitation (e.g., insufficient available memory space of the UE, or used memory space exceeding a threshold amount). In this case, the priority to keep inference results and/or training outcomes can be configured by the base in the RRC release message and/or can be based on the subscription of the UE with an operator network. The UE can also initiate an SDT procedure to send inference results(s) and/or training outcomes(s) to the base station (e.g., while in the RRC inactive state). The reporting here may identify the AI model(s) for which the training outcome(s) and/or inference result(s) are being sent.

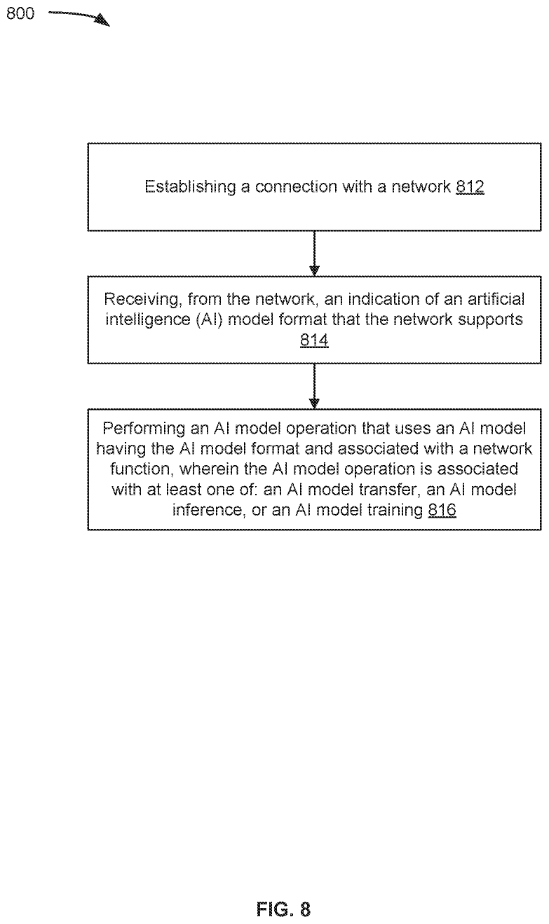

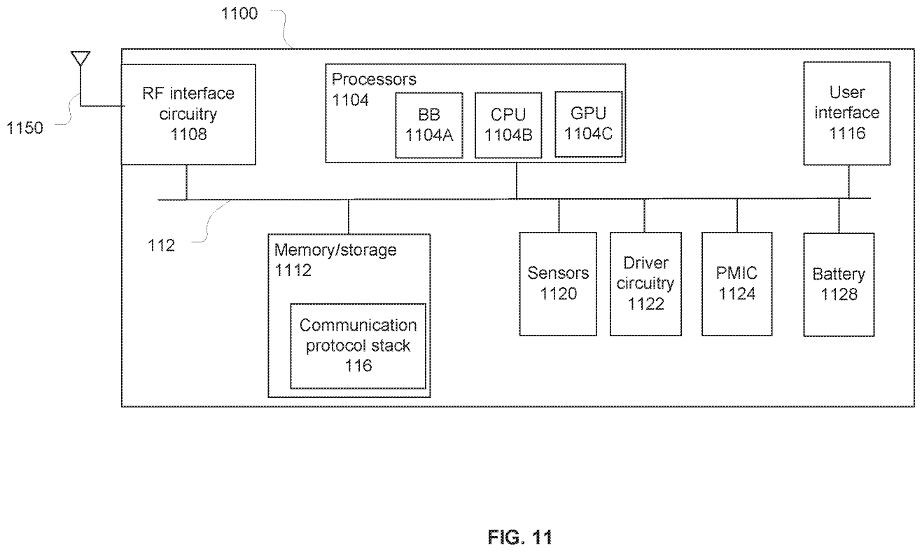

FIG. 8 illustrates an example of an operational flow/algorithmic structure 800 implemented by a UE for coordinating AI model usage with a network in accordance with some embodiments in accordance with some embodiments. The UE can be any of the UEs described herein above. Components of the UE, such as one or more processors thereof, can implement the operational flow/algorithmic structure 800. Such components are further described in FIG. 11.

In an example, the operational flow/algorithmic structure 800 includes, at step 802, establishing a connection with a network. For example, in the context of a 5G NR wireless system, a 3GPP connection procedure can be performed and can include establishing an RRC connection between the UE and a gNB (e.g., by using RRC signaling including, for instance, RRC connection reconfiguration messages), which in turn connects to the 5G CN.

In an example, the operational flow/algorithmic structure 800 includes, at step 804, receiving, from the network, an indication of an AI model format that the network supports. For example, this indication is received according to a UE-initiated AI model format coordination or a network-initiated AI model format coordination. In the case of the UE-initiated AI model format coordination, the UE can indicate, to the network, the AI model formats that the UE supports. In turn, the network indicates back to the UE which of these AI model formats the network also supports. The UE can then select one of the network-supported AI model format(s) (if more than one is supported by the network) or use the one that the network supports (if only one is supported by the network). In the case of the network-initiated AI model format coordination, the network can broadcast an indication of the AI model format(s) that the network supports, and the UE can select one or more of these AI model format(s) for its use.

In an example, the operational flow/algorithmic structure 800 includes, at step 806, performing an AI model operation that uses an AI model having the AI model format and associated with a network function, wherein the AI model operation is associated with at least one of: an AI model transfer, an AI model inference, or an AI model training. The network function can relate to the connection between the UE and the network, to a functionality provided by the UE to the network, and/or a functionality provided by the network to the UE. For example, the AI model can be used for CSI feedback enhancement, beam management, position accuracy enhancement, etc. The AI model operation can be performed prior to a handover and/or after the handover, in which case additional coordination between the UE and the network can be performed. The AI model operation can also be performed prior to and/or after a UE state change, in which case additional coordination between the UE and the network can be performed.

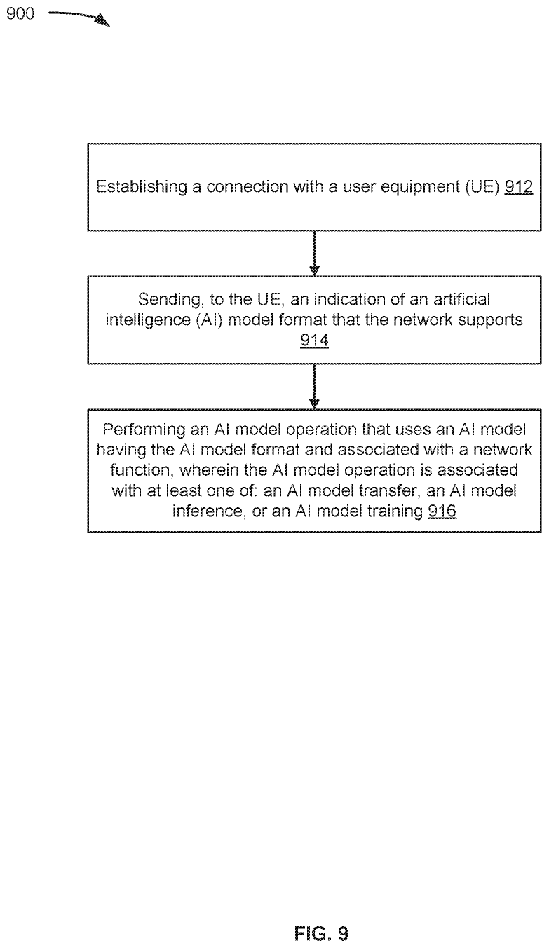

FIG. 9 illustrates an example of an operational flow/algorithmic structure 900 implemented by a network for coordinating AI model usage with a UE in accordance with some embodiments in accordance with some embodiments. The network can include or be a base station, a RAN, or a CN.

In an example, the operational flow/algorithmic structure 900 includes, at step 902, establishing a connection with UE. For example, in the context of a 5G NR wireless system, a 3GPP connection procedure can be performed and can include establishing an RRC connection between the UE and a gNB (e.g., by using RRC signaling including, for instance, RRC connection reconfiguration messages), which in turn connects to the 5G CN

In an example, the operational flow/algorithmic structure 900 includes, at step 904, sending, to the UE, an indication of an artificial intelligence (AI) model format that the network supports. For example, this indication is sent according to a UE-initiated AI model format coordination or a network-initiated AI model format coordination. In the case of the UE-initiated AI model format coordination, the UE can indicate, to the network, the AI model formats that the UE supports. In turn, the network indicates back to the UE which of these AI model formats the network also supports. The UE can then select one of the network-supported AI model format(s) (if more than one is supported by the network) or use the one that the network supports (if only one is supported by the network). In the case of the network-initiated AI model format coordination, the network can broadcast an indication of the AI model format(s) that the network supports, and the UE can select one or more of these AI model format(s) for its use.

In an example, the operational flow/algorithmic structure 900 includes, at step 906, performing an AI model operation that uses an AI model having the AI model format and associated with a network function, wherein the AI model operation is associated with at least one of: an AI model transfer, an AI model inference, or an AI model training. The network function can relate to the connection between the UE and the network, to a functionality provided by the UE to the network, and/or a functionality provided by the network to the UE. For example, the AI model can be used for CSI feedback enhancement, beam management, position accuracy enhancement, etc. The AI model operation can be performed prior to a handover and/or after the handover, in which case additional coordination between the UE and the network can be performed. The AI model operation can also be performed prior to and/or after a UE state change, in which case additional coordination between the UE and the network can be performed.

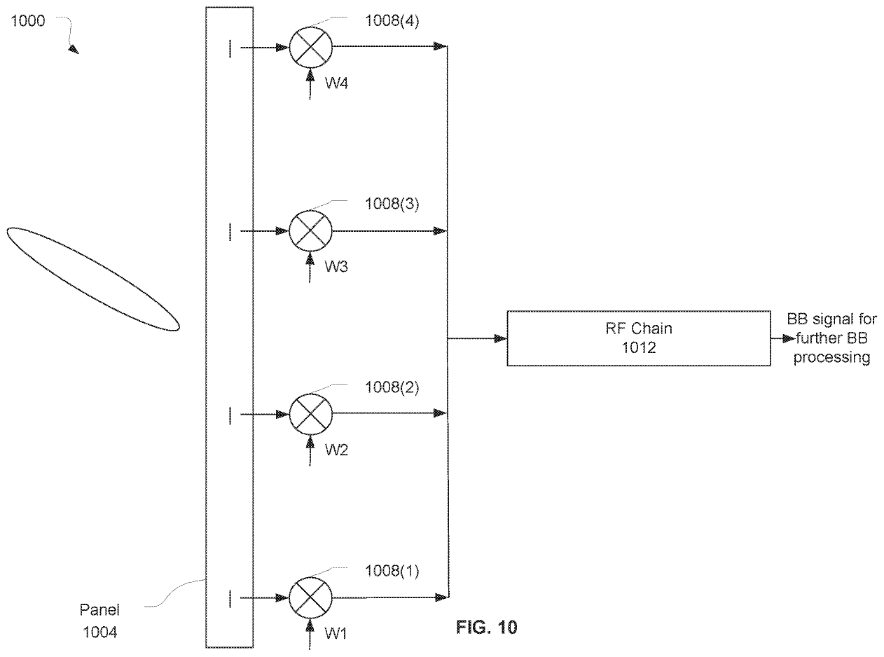

FIG. 10 illustrates receive components 1000, in accordance with some embodiments. A UE, such as any of the above described UEs, can include the receive components 1000. The receive components 1000 may include an antenna panel 1004 that includes a number of antenna elements. The panel 1004 is shown with four antenna elements, but other embodiments may include other numbers.

The antenna panel 1004 may be coupled to analog beamforming (BF) components that include a number of phase shifters 1008(1)-1008(4). The phase shifters 1008(1)-1008(4) may be coupled with a radio-frequency (RF) chain 1012. The RF chain 1012 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1008(1)-1208(4) to provide a receive beam at the antenna panel 1004. These BF weights may be determined based on the channel-based beamforming.

FIG. 11 illustrates a UE 1100, in accordance with some embodiments. The UE 1100 may be similar to and substantially interchangeable with any of the UEs described herein above. A device, such as one described in any of the above figures, can include similar components, including for instance, processors, memory, and RF interface circuitry.

Similar to that described above with respect to the UE 104, the UE 1100 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangements of the components shown may occur in other implementations.

The components of the UE 1100 may be coupled with various other components over one or more interconnects 1132, which may represent any type of interface, input/output, bus (local, system, or expansion), transmission line, trace, optical connection, etc., that allows various circuit components (on common or different chips or chipsets) to interact with one another.

The processors 1104 may include processor circuitry, such as baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1104A may also access group information from memory/storage 1112 to determine search space groups in which a number of repetitions of a PDCCH may be transmitted.

The memory/storage 1112 may include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1150 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1150.

In various embodiments, the RF interface circuitry 1108 may be configured to transmit/receive signals in a manner compatible with NR access technologies.

The antenna 1150 may include a number of antenna elements that each convert electrical signals into radio waves to travel through the air and to convert received radio waves into electrical signals. The antenna elements may be arranged into one or more antenna panels. The antenna 1150 may have antenna panels that are omnidirectional, directional, or a combination thereof to enable beamforming and multiple input, multiple output communications. The antenna 1150 may include microstrip antennas, printed antennas fabricated on the surface of one or more printed circuit boards, patch antennas, phased array antennas, etc. The antenna 1150 may have one or more panels designed for specific frequency bands including bands in FR1 or FR2.

The user interface circuitry 1116 includes various input/output (I/O) devices designed to enable user interaction with the UE 1100. The user interface 1116 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs), or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC Connected state (described herein above as RRC connected state), where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state (described herein above as RRC idle state), where it disconnects from the network and does not perform operations, such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Battery 1128 may power the UE 1100, although in some examples the UE 1100 may be mounted deployed in a fixed location and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

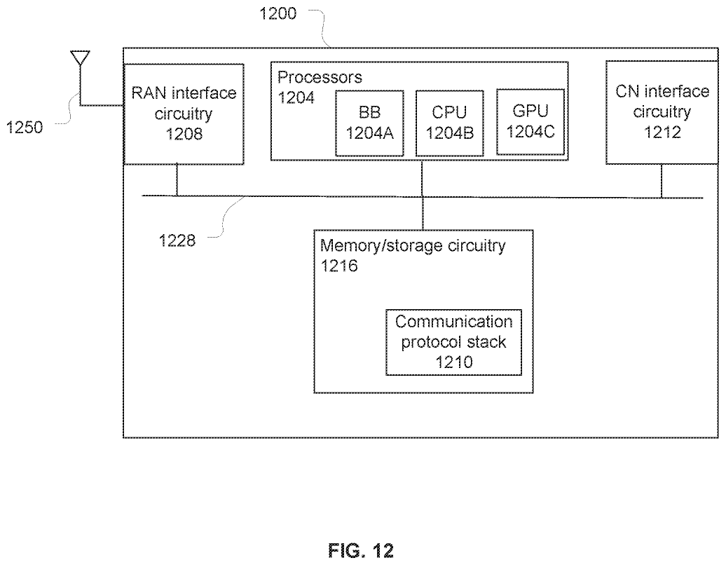

FIG. 12 illustrates a gNB 1200, in accordance with some embodiments. The gNB 1200 may be similar to and substantially interchangeable with the gNB 108 of FIG. 1 and is an example of any of the base stations described herein above.

The gNB 1200 may include processors 1204, RAN interface circuitry 1208, core network (CN) interface circuitry 1212, and memory/storage circuitry 1216. The components of the gNB 1200 may be coupled with various other components over one or more interconnects 1228.

The processors 1204, RAN interface circuitry 1208, memory/storage circuitry 1216 (including communication protocol stack 1210), antenna 1250, and interconnects 1228 may be similar to like-named elements shown and described with respect to FIG. 11.

The CN interface circuitry 1212 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below, For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a user equipment (UE), the method comprising: establishing a connection with a network; receiving, from the network, an indication of an artificial intelligence (AI) model format that the network supports; and performing an AI model operation that uses an AI model having the AI model format and associated with a network function, wherein the AI model operation is associated with at least one of: an AI model transfer, an AI model inference, or an AI model training.

Example 2 includes the method of example 1, further comprising sending: to the network, UE capability information indicating one or more AI model formats that the UE supports, wherein the indication is received based on the UE capability information and indicates, to the UE, that the AI model format is to be used by the UE.

Example 3 includes the method of example 2, wherein the UE capability information is sent in an access stratum (AS) capability message to a base station of the network, and wherein the indication is received in a radio resource control (RRC) message from the base station.

Example 4 includes the method of example 2, wherein the UE capability information is sent in a non-access stratum (NAS) capability message to a core network of the network, and wherein the indication is received in NAS signaling of the core network.

Example 5 includes the method of example 1, further comprising: sending, to the network, metadata that describes one or more AI models, wherein the indication is received based on the metadata and indicates, to the UE, that the AI model format is to be used by the UE.

Example 6 includes the method of example 5, wherein the metadata includes an AI model identifier of the AI model and one or more AI model formats that the UE supports.

Example 7 includes the method of example 1, wherein the indication is received in a broadcast from the network indicating a plurality of AI model formats that the network supports, and wherein the method further comprises: selecting the AI model format from the plurality of AI model formats.

Example 8 includes the method of any example 1 through 7, further comprising: receiving, from a source base station of the network, a handover command; and determining the AI model operation based at least in part on the handover command.

Example 9 includes the method of example 8, further comprising: determining the AI model is to be released based on the handover command, wherein the AI model operation includes at least one of: discarding an unfinished Packet Data Convergence Protocol (PDCP) Protocol Data Unit (PDU) for the AI model transfer; stopping inference and discarding stored inference results for the AI model inference; or stopping training and releasing a training outcome for the AI model training.

Example 10 includes the method of any example 1 through 9, further comprising: receiving, from the network, a radio resource control (RRC) message to enter an idle state; and determining the AI model is to be released based at least in part on the RRC message, wherein the AI model operation includes at least one of: discarding an unfinished Packet Data Convergence Protocol (PDCP) Protocol Data Unit (PDU) for the AI model transfer; stopping inference and discarding stored inference results for the AI model inference; or stopping training and releasing a training outcome for the AI model training.

Example 11 includes the method of any example 1 through 10, further comprising: receiving, from the network, a radio resource control (RRC) message to enter an inactive state, wherein the RRC message includes: a list of AI model identifiers indicating one or more AI models for which the UE is to continue the AI model inference or the AI model training, a timer for each one of the one or more AI models indicating how long the UE is to continue the AI model inference or the AI model training, and a list of cells associated with the AI model inference or the AI model training.

Example 12 includes the method of example 11, wherein the RRC message includes, for each AI model identified in the list of AI model identifiers, an indication of whether to suspend the AI model inference or the AI model training and keep AI model configuration information.

Example 13 includes the method of example 11, wherein the AI model operation includes at least one of: discarding an unfinished Packet Data Convergence Protocol (PDCP) Protocol Data Unit (PDU) for the AI model transfer; releasing any AI model not identified in the list of AI model identifiers, and stopping the AI model inference and discarding stored inference results for any AI model identified in the list of AI model identifiers; or releasing any AI model not identified in the list of AI model identifiers, and stopping the AI model training and releasing a training outcome for any AI model identified in the list of AI model identifiers.

Example 14 includes the method of example 11, wherein the AI model operation includes at least one of: stopping the AI model inference or the AI model training upon an expiration of the timer for the AI model, wherein an inference result of the AI model inference or a training outcome of the AI model training is stored by the UE.

Example 15 includes the method of example 11, wherein the AI model is not identified in the list and is part of the AI model inference or the AI model training, and wherein the AI model operation includes at least one of: releasing the AI model, and stopping the AI model inference and discarding stored inference results for the AI model; or releasing the AI model, and stopping the AI model training and releasing a training outcome; and restarting the timer for the AI model and updating the list of cells.

Example 16 includes the method of any example 1 through 15, further comprising: sending, to the network, an RRCResumeComplete message associated with the UE entering a connected state, wherein the RRCResumeComplete message indicates that the UE has stored an inference result of the AI model inference or a training outcome of the AI model training is stored by the UE.

Example 17 includes the method of any example 1 through 16, further comprising: receiving, from the network, a request to report an inference result of the AI model inference or a training outcome of the AI model training, and sending, based on the request, the inference result or the training outcome to the network.

Example 18 includes the method of example 17, wherein the inference result includes an AI model identifier of the AI model, an inference metric, and a time stamp of when a last inference was performed, and wherein the training outcome includes the AI model identifier, an updated AI model parameter or an update AI model structure, and a time stamp of when a last training was performed.

Example 19 includes the method of any example 1 through 18, further comprising: receiving, from the network, a radio resource control (RRC) to enter an idle state, wherein the AI model operation includes at least one of: stopping inference and discarding stored inference results for the AI model inference; or stopping training and releasing a training outcome for the AI model training.

Example 20 includes the method of any example 1 through 98, further comprising: entering an inactive state, wherein the AI model operation includes stopping the AI model inference or the AI model training.

Example 21 includes the method of example 20, further comprising: determining a priority to keep an inference result of the AI model inference or a training outcome of the AI model training, wherein the priority is configured by the network in radio resource control (RRC) release message or is based on a UE subscription.

Example 22 includes the method of example 20, further comprising: sending, while the UE is in the inactive state, an inference result of the AI model inference or a training outcome of the AI model training to the network according to a small data transmission (SDT) procedure.

Example 23 includes a method implemented by a network, the method comprising: establishing a connection with a user equipment (UE); sending, to the UE, an indication of an artificial intelligence (AI) model format that the network supports; and performing an AI model operation that uses an AI model having the AI model format and associated with a network function, wherein the AI model operation is associated with at least one of: an AI model transfer, an AI model inference, or an AI model training.

Example 24 includes the method of example 23 further comprising: receiving, from the UE, UE capability information indicating one or more AI model formats that the UE supports, wherein the indication is sent based on the UE capability information and indicates, to the UE, that the AI model format is to be used by the UE.

Example 25 includes the method of example 24, wherein the UE capability information is received in an access stratum (AS) capability message by a base station of the network, and wherein the indication is received in a radio resource control (RRC) message by the base station.

Example 26 includes the method of example 25, wherein the base station hosts the AI model, and wherein the RRC message includes an RRCReconfiguration message.

Example 27 includes the method of example 24, wherein the UE capability information is received in a non-access stratum (NAS) capability message by a core network of the network, and wherein the indication is sent in NAS signaling by the core network.

Example 28 includes the method of example 27, wherein the NAS capability message is included in a registration request message, wherein the indication is sent in a registration accept message, and wherein the core network hosts the AI model.

Example 29 includes the method of any example 23 through 28, further comprising: receiving, from the UE, metadata that describes one or more AI models, wherein the indication is sent based on the metadata and on a determination that the network supports the AI model format and indicates, to the UE, that the AI model format is to be used by the UE.

Example 30 includes the method of example 29, wherein the metadata is first metadata that includes an AI model identifier of the AI model and one or more AI model formats that the UE supports, and wherein the indication is sent in second metadata that includes the AI model identifier and indicating a selection of the AI model format.

Example 31 includes the method of any example 23 through 30, wherein the indication is sent in a broadcast indicating a plurality of AI model formats that the network supports.

Example 32 includes the method of any example 23 through 31, wherein the indication is sent in one or more system information block (SIB) messages indicating a plurality of AI model formats that the network supports.

Example 33 includes the method of any example 23 through 31, further comprising: sending, by a source base station of the network to a target base station of the network, a handover request message including an identifier of the AI model, metadata about the AI model, and the AI model format; generating, by the target base station, a decision of whether the AI model is to be kept or be released for the AI model transfer, the AI model inference, or the AI model training; sending, by the target base station to the source base station, a handover acknowledgment message indicating the decision.

Example 34 includes the method of example 33, further comprising: sending, by the source base station to the UE, a handover command indicating the decision.

Example 35 includes the method of any example 23 through 34, further comprising: sending, to the UE, a radio resource control (RRC) message to enter an inactive state, wherein the RRC message includes: a list of AI model identifiers indicating one or more AI models for which the UE is to continue the AI model inference or the AI model training, a timer for each one of the one or more models indicating how long the UE is to continue the AI model inference or the AI model training, and a list of cells associated with the AI model inference or the AI model training.

Example 36 includes the method of any example 23 through 35, includes the method of example 23, further comprising: receiving, from the UE, an RRCResumeComplete message associated with the UE entering a connected state; sending, to the UE, a request to report an inference result of the AI model inference or a training outcome of the AI model training; and receiving, based on the request, the inference result or the training outcome from the UE.

Example 37 includes the method of example 36, wherein the request is sent in an RRCResume message.

Example 38 includes the method of example 36, wherein the request is sent in a UEInformationRequest message after the RRCResumeComplete message is received, and wherein the inference result or the training outcome is received in an UEInformatinoResponse message.

Example 39 includes an apparatus, such as a UE, comprising means to perform one or more elements of a method described in or related to any of examples 1-38, or any other method or process described herein.

Example 40 includes one or more non-transitory computer-readable media comprising instructions to cause an electronic device, such as a UE, upon execution of the instructions by one or more processors of the electronic device, to perform one or more elements of a method described in or related to any of examples 1-38, or any other method or process described herein.

Example 41 includes an apparatus, such as a UE, comprising logic, modules, or circuitry to perform one or more elements of a method described in or related to any of examples 1-38, or any other method or process described herein.

Example 42 includes a method, technique, or process as described in or related to any of examples 1-38, or portions or parts thereof.

Example 43 includes an apparatus, such as a UE, comprising: one or more processors and one or more memory (e.g., one or more computer-readable media) comprising instructions that, when executed by the one or more processors, cause the one or more processors to perform the method, techniques, or process as described in or related to any of examples 1-38, or portions thereof.

Example 44 includes a signal as described in or related to any of examples 1-38, or portions or parts thereof.

Example 45 includes a datagram, information element, packet, frame, segment, PDU, or message as described in or related to any of examples 1-38, or portions or parts thereof, or otherwise described in the present disclosure.

Example 46 includes a signal encoded with data as described in or related to any of examples 1-38, or portions or parts thereof, or otherwise described in the present disclosure.

Example 47 includes a signal encoded with a datagram, IE, packet, frame, segment, PDU, or message as described in or related to any of examples 1-38, or portions or parts thereof, or otherwise described in the present disclosure.

Example 48 includes an electromagnetic signal carrying computer-readable instructions, wherein execution of the computer-readable instructions by one or more processors is to cause the one or more processors to perform the method, techniques, or process as described in or related to any of examples 1-38, or portions thereof.

Example 49 includes a computer program comprising instructions, wherein execution of the program by a processing element is to cause the processing element to carry out the method, techniques, or process as described in or related to any of examples 1-38, or portions thereof.

Example 50 includes a network comprising means to perform one or more elements of a method described in or related to any of examples 1-38, or any other method or process described herein.

Example 51 includes one or more non-transitory computer-readable media comprising instructions to cause a network upon execution of the instructions by one or more processors of the network, to perform one or more elements of a method described in or related to any of examples 1-38, or any other method or process described herein.

Example 52 includes a network comprising logic, modules, or circuitry to perform one or more elements of a method described in or related to any of examples 1-38, or any other method or process described herein.

Example 53 includes a network comprising: one or more processors and one or more memory (e.g., one or more computer-readable media) comprising instructions that, when executed by the one or more processors, cause the one or more processors to perform the method, techniques, or process as described in or related to any of examples 1-38, or portions thereof.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-39. (canceled) 40. An apparatus comprising:
processing circuitry configured to:
cause a connection to be established with a network;
process an indication of an artificial intelligence (AI) model format that the network supports, the indication received from the network; and
perform an AI model operation that uses an AI model having the AI model format and associated with a network function, wherein the AI model operation is associated with at least one of: an AI model transfer, an AI model inference, or an AI model training; and
interface circuity coupled with the processing circuitry to enable communication.

41. The apparatus of claim 40, wherein the processing circuitry is further configured to:
generate, for transmission to the network, UE capability information indicating one or more AI model formats that a user equipment (UE) supports, wherein the indication is received based on the UE capability information and indicates that the AI model format is to be used by the UE, wherein the UE capability information is sent in an access stratum (AS) capability message to a base station of the network or in a non-access stratum (NAS) capability message to a core network of the network, and wherein the indication is received in a radio resource control (RRC) message from the base station or in NAS signaling of the core network.

42. The apparatus of claim 40, wherein the processing circuitry is further configured to:
send, to the network, metadata that describes one or more AI models and includes an AI model identifier of the AI model and one or more AI model formats that a user equipment (UE) supports, wherein the indication is received based on the metadata and indicates, to the UE, that the AI model format is to be used by the UE.

43. The apparatus of claim 40, wherein the indication is received in a broadcast from the network indicating a plurality of AI model formats that the network supports, and wherein the processing circuitry is further configured to:
select the AI model format from the plurality of AI model formats.

44. The apparatus of claim 40, wherein the processing circuitry is further configured to:
process a handover command received from a source base station of the network;
determine the AI model operation based at least in part on the handover command; and
determine the AI model is to be released based on the handover command, wherein the AI model operation includes at least one of:
discarding an unfinished Packet Data Convergence Protocol (PDCP) Protocol Data Unit (PDU) for the AI model transfer;
stopping inference and discarding stored inference results for the AI model inference; or
stopping training and releasing a training outcome for the AI model training.

45. The apparatus of claim 40, wherein the processing circuitry is further configured to:
process a radio resource control (RRC) message to enter an idle state, the RRC message received from the network; and
determine the AI model is to be released based at least in part on the RRC message, wherein the AI model operation includes at least one of:
discarding an unfinished Packet Data Convergence Protocol (PDCP) Protocol Data Unit (PDU) for the AI model transfer;
stopping inference and discarding stored inference results for the AI model inference; or
stopping training and releasing a training outcome for the AI model training.

46. The apparatus of claim 40, wherein the processing circuitry is further configured to:
process a radio resource control (RRC) message to enter an inactive state, wherein the RRC message is received from the network and includes: a list of AI model identifiers indicating one or more AI models for which the a user equipment (UE) is to continue the AI model inference or the AI model training, a timer for each one of the one or more AI models indicating how long the UE is to continue the AI model inference or the AI model training, and a list of cells associated with the AI model inference or the AI model training.

47. The apparatus of claim 40, wherein the processing circuitry is further configured to:
send, to the network, an RRCResumeComplete message associated with ta user equipment (UE) entering a connected state, wherein the RRCResumeComplete message indicates that the UE has stored an inference result of the AI model inference or a training outcome of the AI model training is stored by the UE.

48. The apparatus of claim 40, wherein the processing circuitry is further configured to:
process a request to report an inference result of the AI model inference or a training outcome of the AI model training, the request received from the network; and
generate, based on the request, the inference result or the training outcome to the network, wherein the inference result includes: an AI model identifier of the AI model, an inference metric, and a time stamp of when a last inference was performed, and wherein the training outcome includes the AI model identifier, an updated AI model parameter or an update AI model structure, and a time stamp of when a last training was performed.

49. The apparatus of claim 40, wherein the processing circuitry is further configured to:
process a radio resource control (RRC) to enter an idle state, wherein the AI model operation includes at least one of:
stopping inference and discarding stored inference results for the AI model inference; or
stopping training and releasing a training outcome for the AI model training.

50. The apparatus of claim 40, wherein the processing circuitry is further configured to:
enter an inactive state, wherein the AI model operation includes stopping the AI model inference or the AI model training; and at least one of:
determine a priority to keep an inference result of the AI model inference or a training outcome of the AI model training, wherein the priority is configured by the network in radio resource control (RRC) release message or is based on a user equipment (UE) subscription; or
generate, for transmission while in the inactive state, the inference result of the AI model inference or a training outcome of the AI model training to the network according to a small data transmission (SDT) procedure.

51. A computer-readable storage medium storing instructions that, upon execution by one or more processors, cause operations comprising:
causing a connection to be established with a network;
processing an indication of an artificial intelligence (AI) model format that the network supports, the indication received from the network; and
performing an AI model operation that uses an AI model having the AI model format and associated with a network function, wherein the AI model operation is associated with at least one of: an AI model transfer, an AI model inference, or an AI model training.

52. A method comprising:
causing a connection to be established with a user equipment (UE);
generating, for transmission to the UE, an indication of an artificial intelligence (AI) model format that a network supports; and
performing an AI model operation that uses an AI model having the AI model format and associated with a network function, wherein the AI model operation is associated with at least one of: an AI model transfer, an AI model inference, or an AI model training.

53. The method of claim 52 further comprising:
processing UE capability information received from the UE in an access stratum (AS) capability message and indicating one or more AI model formats that the UE supports, wherein the indication is transmitted by a base station based on the UE capability information in radio resource control (RRC) message and indicates, to the UE, that the AI model format is to be used by the UE, wherein the base station hosts the AI model, and wherein the RRC message includes an RRCReconfiguration message.

54. The method of claim 52 further comprising:
processing UE capability information received by a core network from the UE in a non-access stratum (NAS) capability message and indicating one or more AI model formats that the UE supports, wherein the NAS capability message is included in a registration request message, wherein the indication is sent in a registration accept message, and wherein the core network hosts the AI model.

55. The method of claim 52 further comprising:
receiving, from the UE, first metadata that describes one or more AI models and includes an AI model identifier of the AI model and one or more AI model formats that the UE supports, wherein the indication is transmitted in second metadata based on the first metadata and on a determination that the network supports the AI model format and indicates, to the UE, that the AI model format is to be used by the UE, wherein the second metadata includes the AI model identifier.

56. The method of claim 52, wherein the indication is transmitted in a broadcast indicating a plurality of AI model formats that the network supports or in system information block (SIB) messages indicating a plurality of AI model formats that the network supports.

57. The method of claim 52 further comprising:
transmitting, by a source base station of the network to a target base station of the network, a handover request message including an identifier of the AI model, metadata about the AI model, and the AI model format;
generating, by the target base station, a decision of whether the AI model is to be kept or be released for the AI model transfer, the AI model inference, or the AI model training;
transmitting, by the target base station to the source base station, a handover acknowledgment message indicating the decision; and
transmitting, by the source base station to the UE, a handover command indicating the decision.

58. The method of claim 52 further comprising:
generating, for transmission to the UE, a radio resource control (RRC) message to enter an inactive state, wherein the RRC message includes: a list of AI model identifiers indicating one or more AI models for which the UE is to continue the AI model inference or the AI model training, a timer for each one of the one or more models indicating how long the UE is to continue the AI model inference or the AI model training, and a list of cells associated with the AI model inference or the AI model training.

59. The method of claim 52 further comprising:
processing an RRCResumeComplete message received from the UE and associated with the UE entering a connected state;
generating, for transmission to the UE, a request to report an inference result of the AI model inference or a training outcome of the AI model training; and
processing, based on the request, the inference result or the training outcome received from the UE.
